(19) United States
(12) Patent Application Publication
(10) Pub. No.: US 2007/0239542 A1
(43) Pub. Date: Oct. 11, 2007

(54) SYSTEM AND METHOD FOR MANAGEMENT OF ONLINE ADVERTISING

(76) Inventor: John Shapiro, Overland Park, KS (US)

Correspondence Address: LAW OFFICE OF BRETT N. DORNY, 386 WEST MAIN STREET, SUITE 12A, NORTHBOROUGH, MA, 01532, US

(21) Appl. No.: 11/696,712

(22) Filed: Apr. 4, 2007

Related U.S. Application Data
(60) Provisional application No. 60/789,630, filed on Apr. 5, 2006.

(51) Int. Cl. G06Q 30/00

(52) U.S. Cl. 705/14

(57) ABSTRACT

An online advertising management system and method cooperates with advertiser accounting and other data to provide improved control and performance. The management system assists with determining keywords and ad content through automating certain steps and simplifying others. The management system further monitors performance of an advertising campaign and allows automatic and manual adjustments.

### CROSS-REFERENCE TO RELATED APPLICATIONS

This application claims priority to U.S. Provisional Patent Application Ser. No. 60/789,630, filed Apr. 5, 2006.

### BACKGROUND OF THE INVENTION

1. Field of the Invention

The present invention relates to management of online advertisements. More particularly, it relates to automated or assisted creation, analysis and control of online advertisements.

2. Discussion of Related Art

Traditional means of advertising, such as television, radio, and print, work by placing a brand or an image in front of as many people as possible. Early online advertising followed a similar model of broadcasting a graphic or text advertisement to as many people as possible. Later, advertising campaigns were targeted to specific users. Under these more recent developments, when a user of a search engine conducts a search, advertisements are displayed with search results according to the search terms and other data linked to that user, including advertisements. This technique of displaying ads that are related to the search results is generally known as paid search.

Some search engine providers allow advertisers to create advertisements that are matched to a pre-specified set of keywords. When a user begins a search that includes search terms that are counterparts to the pre-specified keywords, relevant ads, meaning ads that correspond with those keywords, may be displayed to the search engine user. In a pay-per-click (“PPC”) model, when a user selects such an ad by means of a hyperlink (known as a click-through), the advertiser is charged for the advertisement. Some search engine providers have advertisers decide on how much they will pay for each user click-through. This amount is commonly known as the bid. Such search engine providers then decide on the frequency and position of relevant ads by considering a variety of factors, including the bid, the frequency of click-throughs when the ad is displayed, and the estimated travel to the advertiser's site (i.e., traffic estimation) versus the amount remaining in the user's advertising budget for the billing period.

The PPC advertising model can be extremely beneficial to users. However, many users, particularly small business lack the resources to make effective use of such a system or to determine whether their use is effective. The process for creating ads in existing paid-search systems is complex. The advertising campaign must be created manually by having a person create ad copy and input keywords into a search engine advertising interface. The person may have to manually input large lists of keywords. In order to appear more often, many keywords may be used. However, even though the advertisement appears and may be selected, existing systems do not provide any information to the user about the success of the advertisement towards making a sale.

### SUMMARY OF THE INVENTION

The present invention overcomes many of the deficiencies of existing systems through providing an automated system and method for creating and monitoring advertisements.

According to one aspect of the invention, an advertising management system is connected to components of an advertiser computer system. The advertising management system retrieves information from the components of the advertiser computer system for use with management of advertisements. According to one aspect of the invention, the advertising management system generates keywords from information in an advertiser accounting system. According to another aspect of the invention, the advertising management system generates keywords from information in an advertiser system server. According to another aspect of the invention, the advertising management system generates keywords from information in an advertiser database. According to another aspect of the invention, the advertising management system communicates with a third party website to obtain information for generating keywords.

According to another aspect of the invention, the advertising management system communicates with advertisement websites to gather information regarding potential performance of keywords. According to another aspect of the invention, the advertising management system includes a user interface for displaying a list of generated keyword and potential performance information to an advertiser. The advertiser may edit the keyword list using the user interface. According to another aspect of the invention, the advertising management system communicates with an advertisement website to supply advertisements and keywords. According to another aspect of the invention, the advertisement website includes a search engine host.

According to another aspect of the invention, the advertising management system uses gathered information to generate advertisement content. The advertising management system includes templates for creating advertisements. According to another aspect of the invention, the advertising management system communicates with websites to gather information on potential performance of advertisements. According to another aspect of the invention, the advertising management system dynamically modifies the advertisement templates based upon information gathered from websites. According to other aspects of the invention, the websites include a competitors website and/or a search engine host. According to another aspect of the invention, the advertising management system includes a user interface for displaying generated advertisements. The advertiser may edit the advertisement using the user interface.

According to another aspect of the invention, an advertising management system communicates with an advertisement website to obtain information on advertisement performance. According to another aspect of the invention, the advertising management system communicates with the advertiser website to obtain information on advertisement performance. According to another aspect of the invention, the advertising management system communicates with an accounting system to obtain information on advertisement performance. According to another aspect of the invention, the advertising management system dynamically modifies a keyword list based upon advertisement performance. According to another aspect of the invention, the advertising management system dynamically adjusts advertisement content based upon advertisement performance. According to another aspect of the invention, the advertising management system includes a user interface for displaying a keyword list, advertisements and/or advertisement performance information. The advertiser may edit the keyword list and/or advertisements using the user interface.

According to one aspect of the invention, a method for advertising management retrieves information from the components of the advertiser computer system for use in managing advertisements. According to one aspect of the invention, the method for advertising management generates keywords from information in an advertiser accounting system. According to another aspect of the invention, the method for advertising management generates keywords from information in an advertiser system server. According to another aspect of the invention, the method for advertising management generates keywords from information in an advertiser database. According to another aspect of the invention, the method for advertising management includes communicating with a third party website to obtain information for generating keywords.

According to another aspect of the invention, the method for advertising management includes communicating with advertisement websites to gather information regarding potential performance of keywords. According to another aspect of the invention, the method for advertising management includes displaying a list of generated keyword and potential performance information to an advertiser. The advertiser may edit the keyword list. According to another aspect of the invention, the method for advertising management includes communicating with an advertisement website to supply advertisements and keywords. According to another aspect of the invention, the advertisement website includes a search engine host.

According to another aspect of the invention, the method for advertising management includes gathering information to generate advertisement content. Templates are used to create advertisements. According to another aspect of the invention, the method for advertising management includes communicating with websites to gather information on potential performance of advertisements. According to another aspect of the invention, the method for advertising management includes dynamically modifying the advertisement templates based upon information gathered from websites. According to other aspects of the invention, the websites include a competitor's website and/or a search engine host. According to another aspect of the invention, the method for advertising management includes displaying generated advertisements. The advertiser may edit the advertisements.

According to another aspect of the invention, a method for advertising management includes communicating with an advertisement website to obtain information on advertisement performance. According to another aspect of the invention, the method for advertising management includes communicating with the advertiser website to obtain information on advertisement performance. According to another aspect of the invention, the method for advertising management includes communicating with an accounting system to obtain information on advertisement performance. According to another aspect of the invention, the method for advertising management includes dynamically modifying a keyword list based upon advertisement performance. According to another aspect of the invention, the method for advertising management includes dynamically adjusting advertisement content based upon advertisement performance. According to another aspect of the invention, the method for advertising management includes displaying a keyword list, advertisements and/or advertisement performance information. The advertiser may edit the keyword list and/or advertisements.

### BRIEF DESCRIPTION OF THE DRAWINGS

FIG. 1 is a block diagram of a network including an advertising management system according to an embodiment of the present invention.

FIG. 2 is a flow diagram for operation of an advertising management system according to an embodiment of the present invention.

FIG. 3 is a flow diagram for operation of an advertising management system according to an embodiment of the present invention.

FIG. 4 is a flow diagram for operation of an advertising management system according to an embodiment of the present invention.

### DETAILED DESCRIPTION

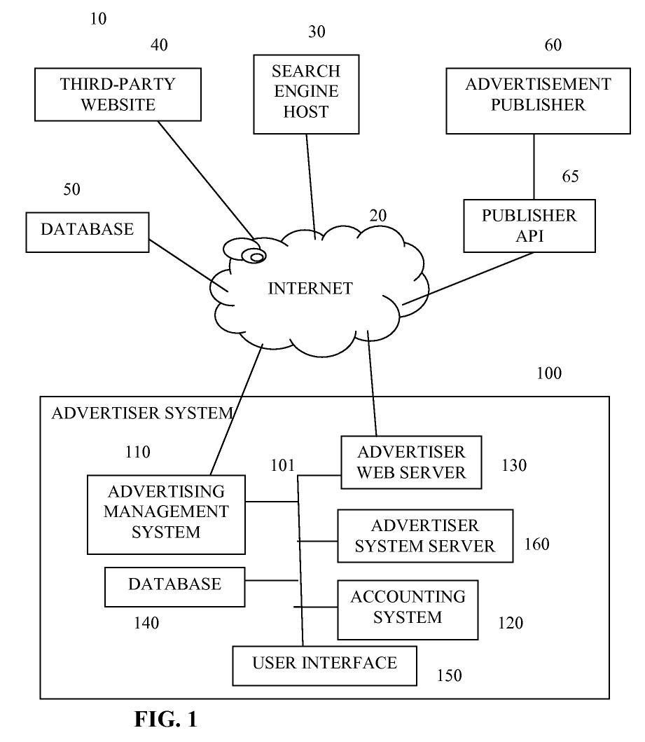

According to an embodiment of the present invention, an advertising management system is used to create, analyze and control online advertisements. FIG. 1 represents a network 10 including an advertising management system of the present invention. As is known, the Internet 20 and/or other wide area or global network, connects together various servers providing services to users. A search engine host 30, such as Yahoo® and Google® provides a searching service for users. (Search engine host 30 is representative of multiple hosts which can be accessed and utilized by the system and method of the present invention.) The search engine host 30 has a connection to the Internet 20. Users are able to access the search engine host 30 through that connection.

When the search engine host 30 receives a request for a search, it returns information relating to a set of relevant websites. As is known, a search engine host 30 also provides a set of advertisements related to the search. The advertisements are selected based upon keywords entered by the advertiser. When a user selects or “clicks” an advertisement, the user is directed, through the Internet 20, to the advertiser's website, hosted on the advertiser web server 130.

The advertiser web server 130 is part of a computer system 100 of the advertiser. The advertiser system 100 may include a single computer or multiple computers. If the advertiser system 100 encompasses multiple computers, one or more separate networks (not shown) link the various computers. The components of the advertiser system may be located at a plurality of locations and may communicate through the Internet 20 as well as through other networks. The components may also be owned or operated by third parties, such as another entity which hosts the advertiser's website, as long as they are used in operation of the business of advertiser.

FIG. 1 illustrates some of the functionality of the advertiser system 100 as it pertains to the present invention. The various components are connected together through datalines 101 or a network (not shown) to form the system. The advertiser web server 130 hosts the advertiser's web site to provide a service to businesses or the public. The service may include providing information about the advertiser or advertiser's products. It may also include an ecommerce service allowing ordering of the advertiser's products. Advertiser system server 160 provides computer services to the advertiser. It may include application programs and accompanying data used by advertiser. It may include one or more computers and storage devices. Accounting system 120 stores or processes information stored in the advertiser's financial and other accounting records. Accounting system 120 runs, for example, Intuit Quickbooks accounting software, produced by Intuit Inc., 2632 Marine Way, Mountain View, Calif. 94043. The accounting system 120 may operate on the advertiser system server 160 or may include separate hardware. The advertiser system 100 includes one or more user interfaces 150 for accessing the functionality of the components of the advertiser system 100. One or more databases 140 may be included in the advertiser system 100.

In the present invention, the advertiser system 100 includes an advertising management system 110 to create, control and manage online advertisements. The advertising management system 110 is connected to the other components of the advertising system in order to provide its functionality. The advertising management system 110 includes a connection to the Internet 20 in order to communicate with other systems outside the advertiser system 100 in providing its functionality.

While FIG. 1 illustrates advertiser system 100 as having separate components, any or all of them may be integrated into a single computer, computer system, or program. For example, the user interface 150 may be integrated into the interface for the accounting system 120. Thus, the advertising management system 110 could be accessed directly through the accounting system 120. Alternatively, the user interface 150 may be integrated with the advertising management system 110. Accounting information may be retrievable by the interface 150 through the connection between the advertising management system 110 and the accounting system 120. Alternatively, the user interface 150 may be a separate GUI interface associated with a computer within the advertiser system 100.

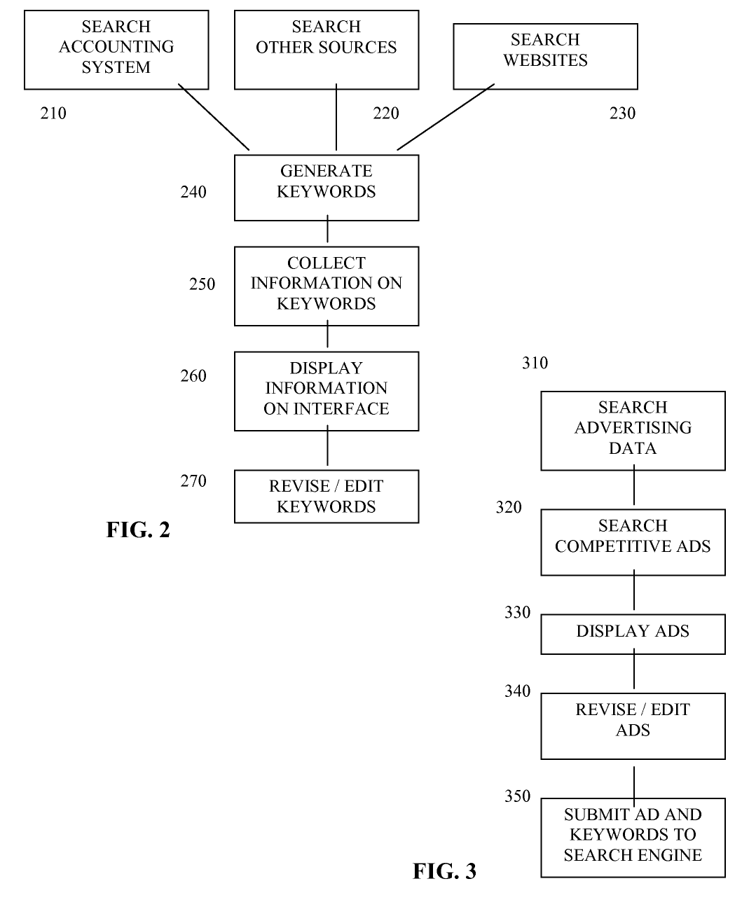

FIG. 2 illustrates a process 200 for operation of the advertising management system 110 to create keywords for use in conjunction with advertisements on a search engine host 30 according to an embodiment of the present invention. The advertising management system 110 determines keywords through a number of data sources. At step 210, the advertising management system 110 searches data created or stored by accounting system 120 to determine words frequently used in connection with sales records, inventory lists, or other business transactions. At step 220, the advertising management system 110 searches the advertiser's website on advertiser server 130 or scanned promotional materials, business email databases, product information or other relevant sources stored in a database 140. At step 230, the advertising management system 110 searches third party websites 40 accessed through the Internet 20. Such third party sites could include industry associations and competitors' websites. The specific sources to be searched by the advertising management system 110 would be identified by the advertiser through the user interface 150 or automatically determined from information accessed from accounting system 120, advertiser web server 130, advertiser system server 160, or database 140.

At step 240, a list of keywords is generated from all of the words culled from different sources. At step 250, the advertising management system 110 collects information relating to use of the various keywords. Such information may be stored in the advertising management system 110 from previous lists, may be obtained from the search engine host 30, or may be culled from various sources connected to the Internet 20. The information may include data on estimated traffic, associated costs, and similar ads using various combinations of the keywords. The information may include an estimation of the average display position that different bids would result in for the keyword combinations. Pricing information for the ads is also obtained.

At step 260, the list of keywords and other collected information is displayed on the user interface 150. The advertiser can then revise and edit the list of keywords at step 260. Once editing is complete, the advertising management system 110 retains the selected keywords for submission with advertisements, as discussed below.

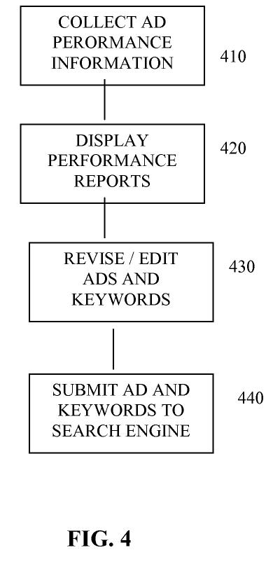

According to an embodiment of the present invention, as illustrated in the process of FIG. 3, the advertising management system 110 provides assistance in creating the advertisements through the collection and presentation of information. Advertising management system 110 accesses the database 140, advertiser web server 130 and/or advertiser system server 160 to collect information for advertisements at step 310. At step 320, advertising management system 110 retrieves information from search engine host 30 relating to competitive ads (e.g., that correspond to the same keywords). Using the collected information, the advertising management system 110 generates and displays suggested ads based upon templates at step 330. These ads are selected to demonstrate recommended wording and structuring. Since ads displayed by search engine host 30 are, at least to some degree, ranked by click-through success, ads listed first by search engine host 30 are likely to have been effective at generating traffic. Therefore, ads listed first are selected more often at step 320. The collected information about third party ads is also displayed. At step 340, using the interface 150, advertiser can edit, delete or add advertisements based upon the suggested ads, examples of third party ads, and general or customized ad templates. The advertising management system 110 automatically sets an initial bid price in conjunction with the selected keywords and ads. The bid price can also be modified by the advertiser. Once the advertisements are complete and prices are set, the advertising management system 110 submits the ad campaign to search engine host 30 through an automatic process which avoids the complex manual entry system. Depending on the particular search engine host 30, limited manual entry may be required. For example, an account may need to be created before step 350 may proceed.

According to an embodiment of the invention, the advertising management system 110 monitors performance of ads after submission. Through monitoring, the advertising management system 110 uses an automated adaptive learning process to revise the suggested ads and keywords. The advertising management system 110 tracks the performance of ads it has previously created and the performance of ads of third parties. The advertising management system 110 may retrieve data from advertiser web server 130, advertiser system sever 160, a database 140 containing, for example, server logs, or a third-party system (not shown). The advertiser may, through user interface 150, specify which metrics are to be optimized. For example, the advertiser may choose revenue, profitability, or other metrics.

According to an embodiment of the invention, as illustrated in FIG. 4, the advertising management system 110 assists with control of an advertising campaign during operation. At step 410, the advertising management system 110 collects ad campaign measurement statistics. Various reports are generated and displayed, at step 420, on the user interface 150 based upon the collected information. The reports may include the current, past, and predicted future states of the campaign. The advertising management system 110 also maintains real-time cost of advertising and revenues generated. As discussed previously, the advertising management system 110 is connected to the accounting system 120. The costs and revenues associated with ads can be directly retrieved from and written to the accounting system 120 or retrieved from another system. Advertiser can display the ad campaign data in a standardized or custom format that allows the advertiser to capture, manipulate, and store the data as he likes. At step 430, the advertiser can revise the ads and/or keywords in the advertising campaign using the user interface 150 based upon the reports generated by the advertising management system 110. The revised ads and keywords are automatically provided to the search engine host 30.

According to another embodiment of the invention, the advertising management system 110 conducts automated experiments to derive empirically optimum bid, keyword, advertisement copy, day or date of placement, and time of placement combinations. Through such experimentation, the advertising management system 110 can derive price elasticity curves for both the advertisement itself, and for the product or service that is being advertised. Through inferred user information indicated by the search engine host 30, advertising management system 110 can optimize price discrimination strategies. The advertising management system 110 can be optimized according to inventory turnover, inventory levels, days receivable, customer lifetime value (which traces all purchases a customer makes and connects that to the initial lead for detailed return-on-investment (“ROI”) analysis), customer up-selling to a more expensive or higher-profit product, order size, shipping costs, geography, profit levels, gross sales, net sales, EBIT, cost-per-click, click-through rates, number, cost, or timing of telephone inquiries, attitudinal changes in target market (e.g., awareness, knowledge, interest) or estimated or known impact on competitors' websites or businesses. For example, consider an optimization strategy that focuses on equivalent sales per click. There could be two keywords: one costs $0.10 per click while another costs $1.00 per click. If the $1.00 per click keyword generates more than 10 times as many equivalent sales per click as does the $0.10 per click keyword, it offers a better ROI.

The advertising management system 110 is adapted to perform the automated analysis and optimization through integration of information tracked by search engine host 30 and accounting system 120. The advertiser may save money by, for example, finding cost-effective advertisements. The advertising management system 110 is also capable of managing, in all the same ways that keywords are otherwise discussed, negative keywords, meaning keywords that will prevent an advertisement from displaying. For example, advertising management system 110 can optimize negative keywords to minimize click-through loss or to minimize buy-through loss.

In an embodiment of the invention, advertising management system 110 collects information by explicitly linking the unique tracking identifier and its associated information (e.g., implied user location) that is created, observed or maintained by the search engine host 30 with the tracking identifier and its associated information that is created or maintained by accounting system 120. For example, the accounting system 120 may have unique customer identifying numbers, customer accounts, email or home addresses, telephone numbers, product warranty numbers, discount coupon numbers, browser cookies, IP addresses, credit card numbers, or any combination thereof. By linking the tracking identifiers, multiple search engine searches can be associated with a single final sale, or, alternatively, a single click-through with multiple sales that occur separately over a period of time after the search engine user first saw an advertisement and clicked on it. By linking all the sales to customers, whether conducted by email, telephone, fax, or internet, with the initial customer acquisition through internet advertising and online identification, a more complete understanding of the revenue per new customer, profit per new customer, and other metrics can be obtained and compared to the cost of acquiring that new customer through online advertising. The advertising management system 110 is adapted to optimize online advertising by measuring online and offline sales. The advertising management system 110 can use the search engine tracking identifier and the accounting system 120 identifier and their related information to calculate optimum pricing levels.

In another embodiment, the advertising management system 110 links a unique tracking identifier and its associated information (usually stored by a cookie on the search engine user's computer) that is created, observed or maintained by the search engine host 30 with the tracking identifier and its associated information that is created or maintained by accounting system 120 in order to allocate automatically certain advertising costs to separate cost-pools in accounting system 120. For example, suppose there is an advertiser that is a lawn mower retailer, and he has a Google ad campaign for lawn mowers assigned a keyword “lawnmower.” The advertiser wishes to assign the ad campaigns costs two cost-pools, one for its riding mower division and another for its push mower division. System 240 can assign click-throughs that result in a riding mower purchases to the riding mower cost-pool, and click-throughs that result in push mower purchases to the push mower cost-pool, and all other click-throughs to these two cost-pools in a similar ratio.

In another embodiment, advertising management system 110 provides advertising cost aggregations to accounting system 120 in order to generate automatic advertising reimbursement invoices. For example, one business forms a partnership that allows it to have some of its advertising costs reimbursed. Advertising management system 110 identifies a specified portion of advertising costs related to certain keywords and automatically generates invoices to the partnership.

In another embodiment, the advertiser system 100 uses the database 140 to store or process business information created, generated, or used by the advertiser. The business information may include information stored in a customer relationship management (CRM) application, a billing system, a mailing database, any customer records, electronic mail programs or systems, checks generated or received in the course of business, transaction records, electronic trade journals, electronic commerce software, or Internet web sites. Advertising management system 110 communicates with the database 140 to retrieve the business information. Advertising management system 110 performs an automated review of information from the database 140 to generate keywords for use in online advertising.

In another embodiment, the advertising management system 110 is a Windows-based application that is adapted to facilitate signing up for and maintaining a paid-search and pay-per-click (“PPC”) advertising campaign. The advertising management system may be designed using the C++ or C# programming languages on the Microsoft Visual Studio .NET platform, produced by Microsoft Corp., 1 Microsoft Way, Redmond, Wash. It communicates with a QuickBooks accounting system using the QuickBooks SDK (QBSDK) and the QuickBooks Foundation Class (QBFC) library, an object-oriented layer developed by Intuit.

The present invention is not limited to advertisements on search engine host 30. In another embodiment of the invention, the advertising management system 110 operates to provide advertisements to any advertisement publisher 60. The advertisement publisher 60 may provide advertisements for banner or other online advertisements, text messages, emails, etc. The advertising management system 110 creates, monitors, controls and optimizes the content and possible keywords of advertisements in accordance with the processes described above. To provide the information regarding the advertisements to the advertisement publisher, the advertising management system 110 communicates through publisher's application program interface 65.

In another embodiment, the advertising management system 110 operates remotely from the advertiser system 100. An application installed in the advertiser system 100 facilitates data analysis and transfer of accounting and sales data from the accounting system 120 to the remote advertising management system 110. The application may also facilitate communications between the advertising management system 110 and other components of the advertiser system 100.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A management system for online advertisements for use in connection with an advertiser computer system including at least one component, the management system comprising:
communication means for receiving advertiser information from the at least one component of the advertiser computer system; and
keyword generating means for generating keywords for online advertisements base upon the advertiser information.

2. The management system according to claim 1 wherein the at least one component includes at least one of an accounting system, an advertiser server system, an advertiser website, and a database.

3. The management system according to claim 1 further comprising:
second communication means for communicating with websites of others to collect information relating to advertisements; and
wherein the keyword generating means generates keywords based upon the information relating to advertisements.

4. The management system according to claim 1 further comprising:
second communication means for communication with websites of others to collect performance information relating to potential performance of the keywords; and
adjustment means for adjusting the keywords based upon the performance information.

5. The management system according to claim 4, further comprising:
a user interface including:
a display for displaying the keywords and the performance information; and
an input allowing user modification of the keywords.

6. The management system according to claim 1, further comprising:
advertisement submission means for providing keywords to an advertising publisher in connection with advertisements.

7. The management system according to claim 6, wherein the advertising publisher includes a search engine host.

8. The management system according to claim 1, further comprising:
ad creation means for creating advertisements based upon the advertiser information.

9. The management system according to claim 8, further comprising:
second communication means for communicating with websites of others to collect information relating to advertisements; and
wherein the ad creation means creates advertisements based upon the information relating to advertisements.

10. The management system according to claim 8 further comprising:
second communication means for communication with websites of others to collect performance information relating to potential performance of advertisements; and
adjustment means for adjusting the advertisements based upon the performance information.

11. The management system according to claim 10, further comprising:
a user interface including:
a display for displaying the advertisements and the performance information; and
an input allowing user modification of the advertisements.

12. The management system according to claim 8, further comprising:
at least one advertisement template; and
wherein the ad creating means creates ads based upon the at least one advertisement template.

13. The management system according to claim 1, further comprising performance means for collecting information regarding performance of advertisements.

14. The management system according to claim 13, wherein the performance means collects information regarding performance of advertisements from an advertiser publisher source.

15. The management system according to claim 13, wherein the performance means collects information regarding performance of advertisements from an accounting system.

16. The management system according to claim 13 further comprising:
ad adjustment means for changing at least one of an advertisement and a keyword based upon the information regarding performance of advertisements.

17. A method for managing online advertisements in connection with an advertiser computer system including at least one component, the method comprising the steps of:
receiving advertiser information from the at least one component of the advertiser computer system; and
generating keywords for online advertisements base upon the advertiser information.

18. The method according to claim 17 wherein the at least one component includes at least one of an accounting system, an advertiser server system, an advertiser website, and a database.

19. The method according to claim 17 further comprising the step of:
communicating with websites of others to collect information relating to advertisements; and
wherein the generating step generates keywords are generated based upon the information relating to advertisements.

20. The method according to claim 17 further comprising the steps of:
communicating with websites of others to collect performance information relating to potential performance of the keywords; and
adjusting the keywords based upon the performance information.

21. The method according to claim 20 further comprising the steps of:
displaying the keywords and the performance information; and
receiving changes to the keywords from a user.

22. The method according to claim 17 further comprising the step of:
providing keywords to an advertising publisher in connection with advertisements.

23. The method according to claim 22, wherein the advertising publisher includes a search engine host.

24. The method according to claim 17 further comprising the step of:
creating advertisements based upon the advertiser information.

25. The method according to claim 24 further comprising the step of:
communicating with websites of others to collect information relating to advertisements; and
wherein the creating step creates advertisements based upon the information relating to advertisements.

26. The method according to claim 24 further comprising the steps of:
communicating with websites of others to collect performance information relating to potential performance of advertisements; and
adjusting the advertisements based upon the performance information.

27. The method according to claim 26 further comprising the steps of:
displaying the advertisements and the performance information; and
modifying the advertisements based upon user input.

28. The method according to claim 17 further comprising the step of collecting information regarding performance of advertisements.

29. The method according to claim 28 wherein the collecting step includes collecting information regarding performance of advertisements from an advertiser publisher source.

30. The method according to claim 28 wherein the collecting step includes collecting information regarding performance of advertisements from an accounting system.

31. The method according to claim 28 further comprising the step of changing at least one of an advertisement and a keyword based upon the information regarding performance of advertisements.

32. A management system for online advertisements for use in connection with an advertiser accounting system, the management system comprising:
at least one advertisement submitted to an advertising publisher;
a plurality of keywords associated with the at least one advertisement in connection with presentation of the at least one advertisement by the advertising publisher;
communication means for collecting performance information regarding performance of the at least one advertisement and the plurality of keywords from the advertiser accounting system.

33. The management system according to claim 32 further comprising:
adjustment means for changing the plurality of keywords based upon the performance information.

34. The management system according to claim 33 wherein the adjustment means includes means for changing a bid price for at least one of the plurality of keywords.

35. The management system according to claim 33 wherein the adjustment means includes means for deleting a keyword.

36. The management system according to claim 32 further comprising:
a user interface including a display for displaying the plurality of keywords and the performance information.

37. The management system according to claim 36 wherein the user interface further includes input means for receiving user changes to at least one of the plurality of keywords and the at least one advertisement.

38. The management system according to claim 32 wherein the management system is integrated with the advertiser accounting system.

39. A method for managing online advertisements for use in connection with an advertiser accounting system, the online advertisements including at least one advertisement and a plurality of keywords associated with the at least one advertisement, the method comprising the steps of:
collecting performance information regarding performance of the at least one advertisement and the plurality of keywords from the advertiser accounting system; and
changing the plurality of keywords based upon the performance information.

40. The method according to claim 39 wherein the changing step includes changing a bid price for at least one of the plurality of keywords.

41. The method according to claim 39 wherein the changing step includes deleting a keyword.

42. The method according to claim 39 further comprising the steps of:
displaying the plurality of keywords and the performance information; and
receiving user changes to at least one of the plurality of keywords and the at least one advertisement.
